(19) United States
(12) Patent Application Publication
(10) Pub. No.: US 2016/0191433 A1
(43) Pub. Date: Jun. 30, 2016

(54) SERVERS, SERVER CONTROL METHODS AND NON-TRANSITORY COMPUTER-READABLE MEDIUMS

(71) Applicant: LINE Corporation, Tokyo (JP)

(72) Inventor: Suyeon SONG, Seongnam-si (KR)

(21) Appl. No.: 14/838,565

(22) Filed: Aug. 28, 2015

(30) Foreign Application Priority Data
Dec. 26, 2014 (JP) 2014-265526

(51) Int. Cl. H04L 12/58; H04L 29/06

(52) U.S. Cl. CPC H04L 51/10; H04L 51/38; H04L 51/046; H04L 63/10

(57) ABSTRACT

In a server, a transceiver is configured to receive a request for content from a first terminal device through a first application, and to transmit response data to the first terminal device and a second terminal device. At least one memory is configured to store permission information indicative of whether the first terminal device and the second terminal device are permitted to access the requested content, the at least one memory having computer-readable instructions stored therein. At least one processor is configured to execute the computer-readable instructions to: determine whether the second terminal device is permitted to access the requested content based on the permission information stored in the memory; and generate the response data based on a result of the determination.

### CROSS-REFERENCE TO RELATED APPLICATION(S)

This application claims priority under 35 U.S.C. §119 to Japanese Patent Application No. 2014-265526, filed on Dec. 26, 2014, in the Japanese Patent Office, the entire contents of which are incorporated herein by reference.

### BACKGROUND

1. Field

One or more example embodiments relate to servers, server control methods, and/or non-transitory computer-readable storage mediums, for service systems in which content is shared between terminals configured to exchange messages with each other using one or more messaging applications.

2. Description of the Related Art

In recent years, there are many messaging applications for so-called “chatting”, which allow a plurality of user terminals to exchange messages via a network (hereinafter simply abbreviated as “message app(s)”). One such message app is discussed in Japanese Patent Laid-Open No. 2012-252699.

In performing this kind of chatting, there is a demand for sharing not only text messages, but also content such as music and/or video with chat companions. In response to the demand, the message app described in Japanese Patent Laid-Open No. 2012-252699 allows for transmission of a message including a Uniform Resource Locator (URL) address of a website on which music and/or video can be heard and/or viewed, to a chat companion. Upon receipt of the message, the chat companion selects the URL included in the message to access the linked website to listen to the music and/or view the video.

However, in the aforementioned method, in order to listen to music or view video, a new website is opened, which may hinder a chatroom for chatting from being shown on the display screen of the user terminal. Where the user terminal is a relatively small mobile terminal, such as a smartphone or a tablet terminal, this may become a relatively significant issue because the display screen on these terminals is relatively small. In order to return to the chatting and input a subsequent message, the user needs to minimize the window of the website to display the chatroom again, which is troublesome for the user.

Furthermore, there are cases where a link destination of a URL included in a message received from a chat companion is a file requiring installation of a dedicated application (which may simply be abbreviated as “app(s)” below). If the application is not installed on a terminal of a user that has received the message, then the user is unable to listen to the music and/or view the video.

### SUMMARY

Example embodiments provide servers, methods, and/or non-transitory computer-readable storage mediums, configured to improve and/or enhance user-friendliness in terms of playing content (e.g., multimedia, such as music, video, etc.) during chatting.

A server according to one or more example embodiments is a server to be connected to a terminal device (user terminal) via a network. The server includes: a reception unit configured to receive request data for content (e.g., music, video, and the like) from a first terminal device configured to transmits/receives data to/from a second terminal device using a first application; a storage unit configured to store permission information including information relating to permission to use the content related to the request data; a determination unit configured to, based on the permission information stored in the storage unit, determine whether or not the second terminal device has permission to use the content; a creation unit configured to, based on a result of the determination by the determination unit, create response data for the request data for the content from the first terminal device, for the first terminal device and the second terminal device; and a transmission unit configured to transmit the response data created by the creation unit, to the first terminal device and the second terminal device, wherein if the determination unit determines that the second terminal device has permission to use the content, then the creation unit is configured to create the response data so that the second terminal device plays the content at a first level, and if the determination unit determines that the second terminal device has no permission to use the content, then the creation unit is configured to create the response data so that the second terminal device plays the content at a second level, which is inferior to the first level.

At least one example embodiment provides a server comprising: a transceiver configured to receive a request for content from a first terminal device through a first application, and to transmit response data to the first terminal device and a second terminal device; at least one memory configured to store permission information indicative of whether the first terminal device and the second terminal device are permitted to access the requested content, the at least one memory having computer-readable instructions stored therein; and at least one processor. The at least one processor is configured to execute the computer-readable instructions to: determine whether the second terminal device is permitted to access the requested content based on the permission information stored in the memory; and generate the response data based on a result of the determination. If the second terminal device is permitted to access the requested content, then the at least one processor is configured to execute the computer-readable instructions to generate the response data enabling the second terminal device to play the requested content at a first level. If the second terminal device is not permitted to access the requested content, then the at least one processor is configured to execute the computer-readable instructions to generate the response data enabling the second terminal device to play the requested content at a second level, the second level being inferior to the first level.

According to at least some example embodiments, the first application may be a messaging application configured to exchange messages between the first terminal device and the second terminal device; and the request for content may be transmitted as a message by the first terminal device.

If the second terminal device is not permitted to access the requested content, then the at least one processor may generate the response data enabling the second terminal device to play only a portion of the requested content.

If the second terminal device is permitted to access the requested content, then the at least one processor may generate the response data enabling the second terminal device to play the entirety of the requested content.

If the second terminal device is not permitted to access the requested content, then the at least one processor may generate the response data enabling the second terminal device to play the requested content only with a low quality.

If the second terminal device is not permitted to access the requested content, then the at least one processor may generate the response data enabling the second terminal device to play the requested content with a high quality.

The permission information may include use time information indicative of a total time during which the requested content is accessible by the second terminal device. The at least one processor may be configured to execute the computer-readable instructions to: determine, based on the use time information, whether the total time during which the second terminal device is able to access the requested content is limited; and determine whether the total time is decreased by accessing the requested content.

If the total time in which the second terminal device is able to access the requested content is limited and the total time is decreased by accessing the requested content, then the at least one processor is configured to execute the computer-readable instructions to generate, for the second terminal device, the response data asking whether to play the entirety of the requested content.

At least one other example embodiment provides a method for controlling a server. The method comprises: receiving a request for content from a first terminal device through a first application; determining whether a second terminal device is permitted to access the requested content based on stored permission information, the stored permission information being indicative of whether the first terminal device and the second terminal device are permitted to access the requested content; generating, based on a result of the determining, response data for the first terminal device and the second terminal device, the generated response data being associated with the request for content from the first terminal device; and transmitting the generated response data to the first terminal device and the second terminal device. If the determining determines that the second terminal device is permitted to access the requested content, then the generating generates the response data enabling the second terminal device to play the requested content at a first level. If the determining determines that the second terminal device is not permitted to access the requested content, then the generating generates the response data enabling the second terminal device to play the requested content at a second level, the second level being inferior to the first level.

At least one other example embodiment provides a non-transitory computer-readable storage medium having embodied thereon computer-executable instructions that, when executed, causes the computer to execute a method comprising: receiving a request for content from a first terminal device through a first application; determining whether a second terminal device is permitted to access the requested content based on stored permission information, the stored permission information being indicative of whether the first terminal device and the second terminal device are permitted to access the requested content; generating, based on a result of the determining, response data for the first terminal device and the second terminal device, the generated response data being associated with the request for content from the first terminal device; and transmitting the generated response data to the first terminal device and the second terminal device. If the determining determines that the second terminal device is permitted to access the requested content, then the generating generates the response data enabling the second terminal device to play the requested content at a first level. If the determining determines that the second terminal device is not permitted to access the requested content, then the generating generates the response data enabling the second terminal device to play the requested content at a second level, the second level being inferior to the first level.

According to at least some example embodiments, the method may further include storing the permission information indicative of whether the first terminal device and the second terminal device are permitted to access the requested content.

One or more example embodiments may suppress and/or eliminate the need to take trouble to access a website in order to play media, such as music and/or video content, transmitted from a chat companion during chatting, thereby suppressing a user's feeling of troublesomeness. Furthermore, even if the user has no license to use and/or access content necessary for playing the media content transmitted from the chat companion, the music or video may be played at a certain level, which is more convenient for the user.

### BRIEF DESCRIPTION OF THE DRAWINGS

Example embodiments will be described in more detail with regard to the drawings in which:

FIG. 1 is a schematic diagram of a configuration of a service system according to an example embodiment;

FIG. 2 is a block diagram of a server according to an example embodiment;

FIG. 3 is a block diagram of a terminal device according to an example embodiment;

FIG. 4 is a schematic diagram illustrating an example permission information table, according to an example embodiment;

FIG. 5 is a flowchart illustrating a processing method according to an example embodiment;

FIGS. 6A, 6B and 6C are diagrams, each illustrating an example display screen for terminal A chatting with terminal B;

FIGS. 7A, 7B, 7C and 7D are diagrams, each illustrating an example display screen for terminal B chatting with terminal A; and

FIG. 8 is a diagram illustrating an example display screen for terminal A chatting with terminal B.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, some example embodiments are described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Example embodiments will be described in detail with reference to the accompanying drawings. Inventive concepts, however, may be embodied in various different forms, and should not be construed as being limited only to the illustrated example embodiments. Rather, these embodiments are provided as examples so that this disclosure will be thorough and complete, and will fully convey inventive concepts to those skilled in the art. Accordingly, known processes, elements, and techniques are not described with respect to some of the example embodiments of inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure is illustrated in a cross-sectional view, an electronic device may include a plurality of the device structures, as would be illustrated by a plan view of the electronic device. The plurality of device structures may be arranged in an array and/or in a two-dimensional pattern.

It will be apparent to those skilled in the art that various modifications and variations can be made to the example embodiments without departing from the spirit or scope of example embodiments described herein. Thus, it is intended that the example embodiments cover the modifications and variations of the example embodiments provided they come within the scope of the appended claims and their equivalents.

Hereinafter, example embodiments will be described in detail with reference to the accompanying drawings. In this regard, the same or corresponding elements will be denoted by the same reference numerals and will not be redundantly described herein.

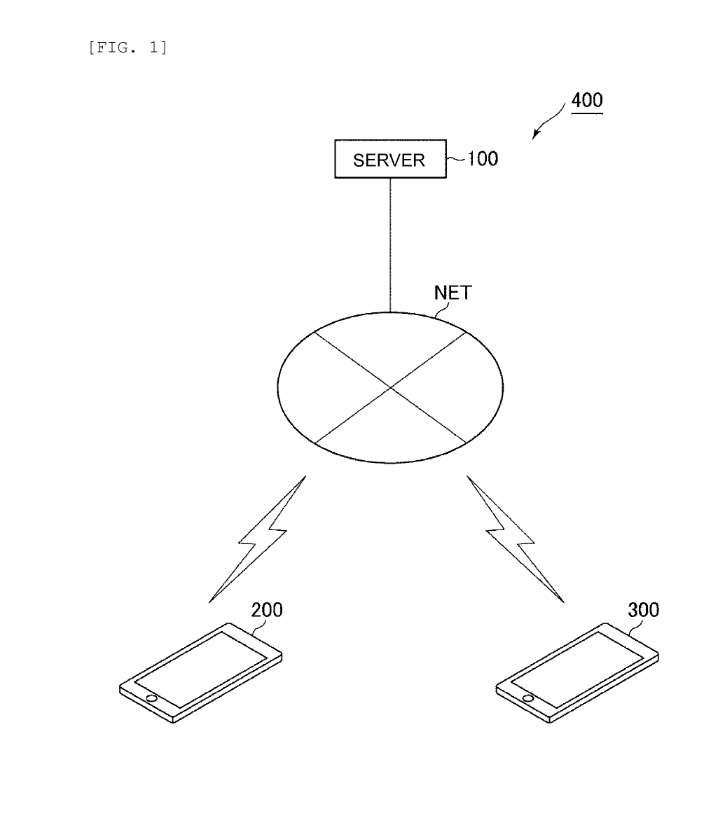

FIG. 1 is a schematic diagram of a configuration of a service system according to an example embodiment.

Referring to FIG. 1, the service system 400 includes a server 100, a terminal device 200 and a terminal device 300. The server 100 is connected to the terminal device 200 and the terminal device 300 via a network NET. Here, for ease of description, FIG. 1 illustrates only two terminal devices; however, it should be understood that there may be three or more terminal devices.

The terminal device 200 and the terminal device 300 are communication terminals exemplified by, for example, smartphones. The terminal device 200 and the terminal device 300 chat using a message app. The server 100 receives a message transmitted by the terminal device 200 via the network NET, and transmits the message to the terminal device 300. The server 100 also receives a message transmitted by the terminal device 300 via the network NET, and transmits the message to the terminal device 200. In addition, the server 100 receives operational instructions input by users via input reception units of the terminal device 200 and the terminal device 300, and performs processing according to the respective instructions.

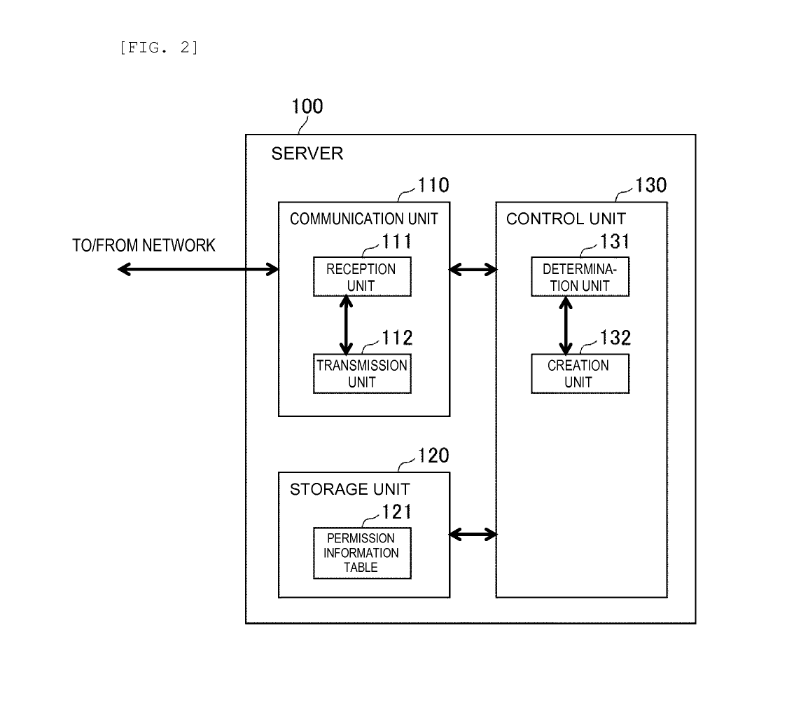

FIG. 2 is a block diagram of the server 100 according to an example embodiment.

As illustrated in FIG. 2, the server 100 includes a communication unit 110, a storage unit 120 and a control unit 130.

The communication unit (also referred to herein as a transceiver) 110 has a function that performs communication with the terminal device 200 and the terminal device 300 via the network NET, according to instructions from the control unit 130. The communication may be wired and/or wireless, and any communication protocol may be employed as long as mutual communication is possible.

The communication unit 110 includes a reception unit 111 and a transmission unit 112. Each of the reception unit 111 and the transmission unit 112 may include one or more interfaces, antennas, and corresponding circuitry, for transmitting/receiving data over a wired and/or wireless connection.

The reception unit 111 receives request data for content such as music and/or video from the terminal device 200 that transmits/receives messages (data) to/from the terminal device 300 using a messaging application (a given, or alternatively, desired or predetermined application). The request data includes information on content the user of the terminal device 200 wishes to share with the user of the terminal device 300, or wishes to recommend to the user of the terminal device 300. Also, the request data is data relating to an application for playing content such as music and/or video (hereinafter simply abbreviated as “content playback application”. Although the description will be provided in terms of a manner in which the terminal device 200 transmits request data, the same applies to cases where the terminal device 300 transmits request data.

The reception unit 111 receives app information regarding whether or not the terminal devices 200 and 300 include a content playback application for content playback, from the terminal devices 200 and 300.

The transmission unit 112 transmits response data for request data received from the terminal device 200, to the terminal device 300. Details of the request data and the response data will be provided in more detail later.

The storage unit 120 (also referred to as a storage device or memory) has a function that stores various programs and data necessary for the server 100 to operate. For example, the storage unit 120 stores a permission information table 121. The permission information table 121 includes information relating to permission to use and/or access content in a content playback application. In other words, for example, the permission information table 121 stores information regarding whether or not the terminal device 200 and the terminal device 300, which are connected to the server 100 via the network NET, are permitted to use and/or access content in a content playback application. Details of the permission information table 121 will be provided later. The storage unit 120 may be provided by any of various types of recording mediums such as HDDs (hard disc drives), SSDs (solid-state drives), flash memories, etc.

Still referring to FIG. 2, the control unit 130 includes processing circuitry having a function that controls the respective units of the server 100. In at least one example, the control unit 130 may be a processor. The control unit 130 includes a determination unit 131 and a creation unit 132. The creation unit 132 may also be referred to as a generating unit 132. Based on the permission information table 121 stored in the storage unit 120, the determination unit 131 determines whether or not the terminal device 300 is permitted to use and/or access content in the content playback application. Based on a result of the determination by the determination unit 131, the creation unit 132 creates response data for request data transmitted from the terminal device 200, for the terminal device 200 and the terminal device 300.

If the determination unit 131 determines that the terminal device 300 is permitted to use and/or access content in the content playback application, then the creation unit 132 creates response data so that the terminal device 300 fully plays the content transmitted by the terminal device 200 (produces the content at a first level). Therefore, the user can listen to/view the full (or entirety of the) content via the terminal device 300. If the determination unit 131 determines that the terminal device 300 is not permitted to use and/or access content in the content playback application, then the creation unit 132 creates response data so that the terminal device 300 plays only part (or a portion) of the content transmitted by the terminal device 200 (plays the content at a second level). Therefore, the user can listen to/view only a sample of the content via the terminal device 300.

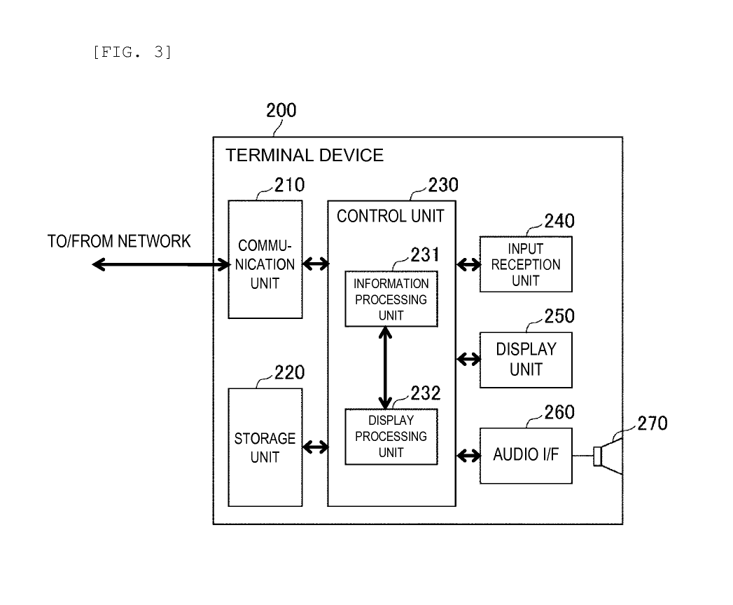

Next, the terminal devices will be described in more detail with regard to FIG. 3.

FIG. 3 is a block diagram of the terminal device 200 according to an example embodiment. Although the description will be provided in terms of the terminal device 200, the same applies to the terminal device 300.

As illustrated in FIG. 3, the terminal device 200 includes a communication unit 210, a storage unit 220, a control unit 230, an input reception unit 240, a display unit 250, an audio interface (I/F) 260 and a speaker 270. The control unit 230 includes an information processing unit 231 and a display processing unit 232. The communication unit 210 may include one or more interfaces, antennas, and corresponding circuitry, for transmitting/receiving data over a wired and/or wireless connection. In the example embodiment shown in FIG. 3, the communication unit 210 has a function that communicates with the server 100 via the network NET. The communication may be wired and/or wireless, and any communication protocol may be employed as long as mutual communication is possible.

The storage unit (also referred to as a storage device or memory) 220 has a function that stores various programs and various data necessary for the terminal device 200 to operate. For example, the storage unit 220 stores information for at least a messaging application and a content playback application downloaded from respective application servers and installed in the terminal device 200. The storage unit 220 may be provided by any of various types of recording mediums such as, typically, HDDs (hard disc drives), SSDs (solid-state drives), flash memories, etc.

The input reception unit 240 receives an input from a user and transmits information relating to the input to the control unit 230. The input reception unit 240 may be provided by, for example, a touch panel, which detects contact with a finger of a user or an instruction tool such as a stylus and a position of the contact, and transmits coordinates of the position at which the contact is detected to the information processing unit 231. In at least this example embodiment, the input reception unit 240 receives, for example, an input of a chat message by the user and a tap of various icons and menu buttons displayed on the display unit 250.

The control unit 230 includes processing circuitry having a function that controls the respective units of the terminal device 200. In at least one example embodiment, the control unit 230 may be a processor configured by executing computer-readable instructions to include an information processing unit 231 and a display processing unit 232. The information processing unit 231 has a function that performs control according to information input from the input reception unit 240 so as to transmit data from the communication unit 210 to the server 100. Also, the information processing unit 231 has a function that transmits a message received by the communication unit 210 from the server 100, to the display processing unit 232. Furthermore, the information processing unit 231 has a function that provides an instruction to the communication unit 210 according to an input from a user to the input reception unit 240 so as to start up (or initiate) a content playback application, and transmit request data for transmitting information for content to the terminal device 300, to the server 100. Furthermore, the information processing unit 231 may have a function that provides an instruction to the communication unit 210 so as to transmit app information regarding whether or not a content playback application is provided (e.g., information regarding whether or not a playback application for playing content is installed), to the server 100.

The display processing unit 232 has a function that converts display data transmitted from the information processing unit 231 into pixel information and writes the pixel information into a frame buffer in the display unit 250. The display unit 250 may be a monitor having a function that displays an image according to the display data written in the frame buffer by the display processing unit 232 of the control unit 230. Furthermore, the display processing unit 232 has a function that provides an instruction to the display unit 250 so as to display a video played in the content playback application and/or display a status bar when music is played.

The audio I/F 260 is an interface for the speaker 270 and earphones (not shown). For playing music and/or video content received from the server 100, the control unit 230 causes the speaker 270 and/or earphones to output sound via the audio I/F 260.

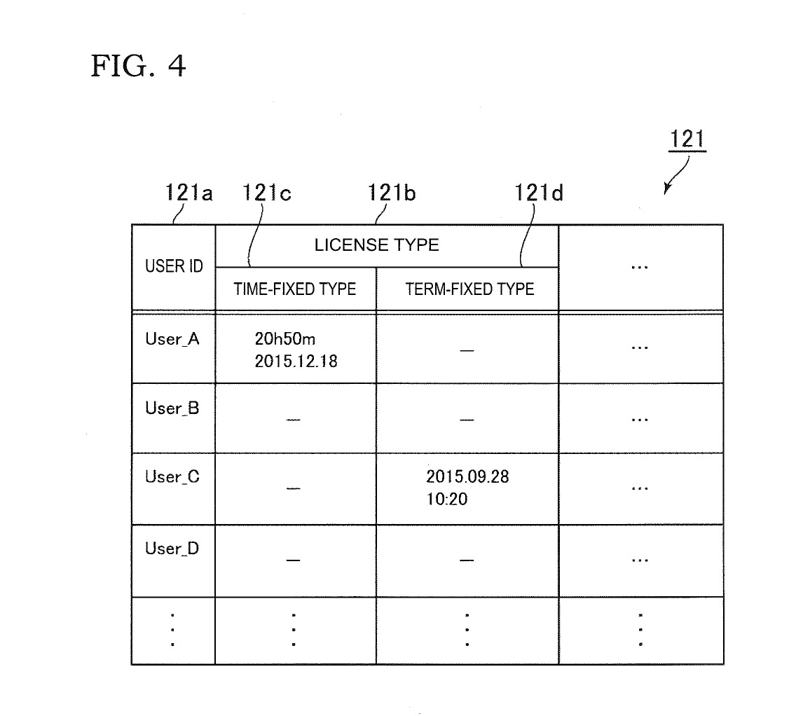

Next, the permission information table 121 will be described in more detail with regard to FIG. 4.

FIG. 4 is a schematic diagram illustrating an example embodiment of the permission information table 121.

Referring to FIG. 4, the permission information table 121 stores information on a type of a license to use and/or access content in a content playback application for each user. According to at least one example embodiment, a license refers to permission to use and/or access content data in the content playback application.

Here, a content playback application and a license to use the content playback application according to an example embodiment will be described. A content playback application (referred to as, e.g., “LINE Music”) is downloaded from an application server and installed on a terminal device. The terminal device with the content playback application installed thereon enables content distributed from a content server to be listened to and/or viewed by purchasing a license. In one example, there are two types of licenses, “time-fixed type” and “term-fixed type”.

The “time-fixed type” is provided to purchase a length of time for content listening and/or viewing, and provides a use mode in which the amount of the time of the playback is subtracted from the total time when content is played. Here, the purchased time has a time limit for use.

The “term-fixed type” is provided to purchase a term in which content can be listened to and/or viewed, and provides a use mode in which content on the relevant site can be listened to and/or viewed freely within the purchased term. Here, when the term expires, no content can be listened to and/or viewed.

Content is streamed to a terminal device, and the terminal device receives the content via a network, enabling the content to be listened to and/or viewed. Here, the content can be listened to and/or viewed after being stored (e.g., temporarily stored) in a storage unit at the terminal device.

Returning to FIG. 4, the permission information table 121 includes items such as user ID 121a and LINE Music license types 121b. The license types 121b further include items of time-fixed type 121c (use time information) and term-fixed type 121d.

For example, referring to the first row of the permission information table 121, a user with a user ID of “User_A” chose the “time-fixed type” to purchase a LINE Music license, and the remaining total time is “20 hours and 50 minutes”, and the time limit for use of the license is “Dec. 18, 2015”. Although a case where the “time-fixed type” license has a time limit for use is indicated here, there may be a case where no expiration date is set. In other words, for example, it is possible that content can be listened to and/or viewed until the purchased total time is consumed.

Referring to the second row of the permission information table 121, it can be seen that a user with a user ID of “User_B” has no LINE Music license. Also, referring to the third row of the permission information table 121, it can be seen that a user with a user ID of “User_C” chose the “term-fixed type” to purchase the license and the expiration time and date of the license is “10:20 on Sep. 28, 2015”. Furthermore, referring to the fourth row, it can be seen that a user with a user ID of “User_D” has no license.

Based on the information stored in the permission information table 121, the determination unit 131 at the server 100 determines whether or not a terminal device that has received information for content from a chat companion has a license to use and/or access content in the content playback application.

Next, example operation of a service system according to an example embodiment will be described with reference to a flowchart and transition diagrams of display screens of terminal devices. Hereinafter, the description will be provided with the terminal device 200 regarded as “terminal A” and the terminal device 300 as “terminal B”.

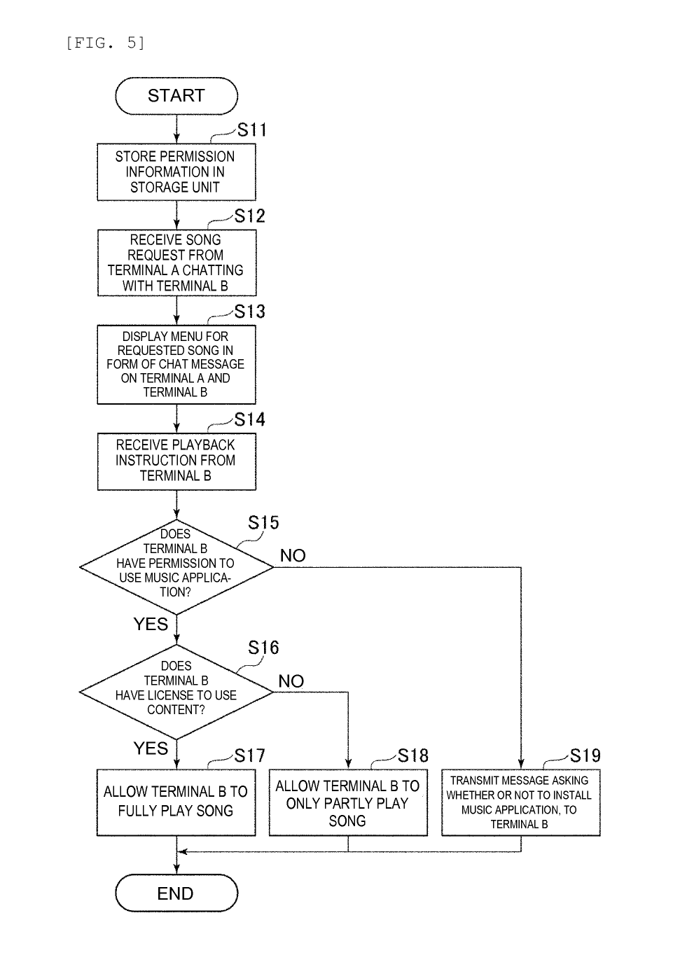

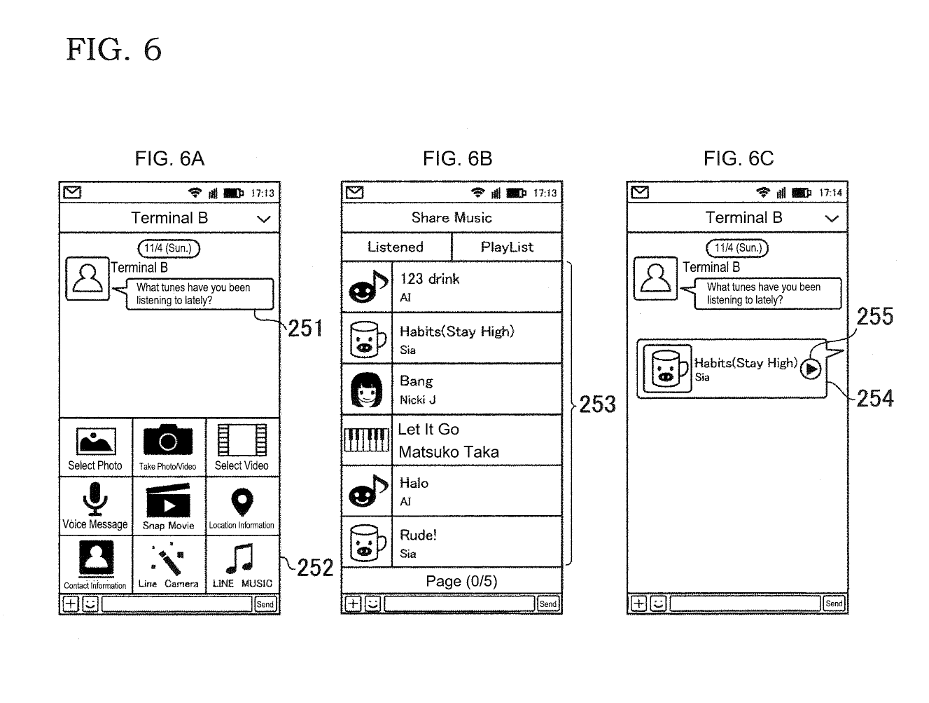

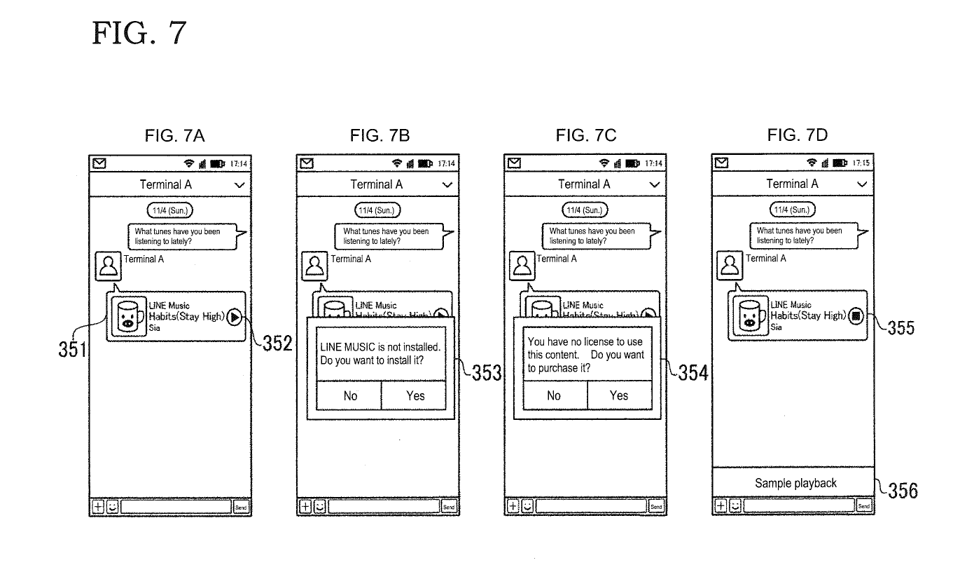

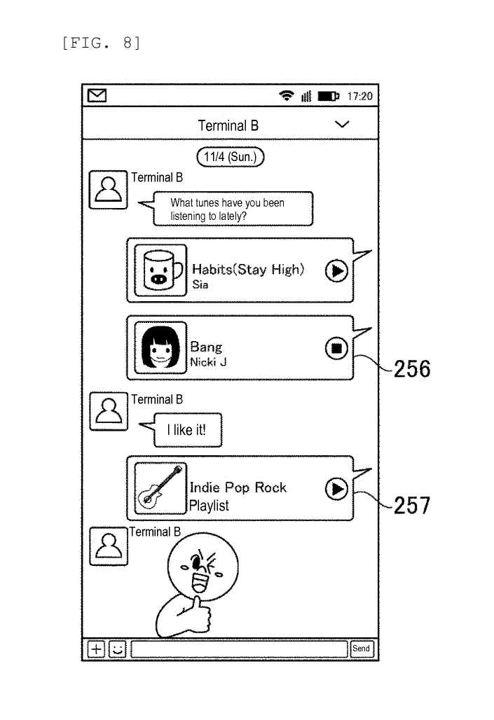

FIG. 5 is a flowchart illustrating a processing method, according to an example embodiment. FIGS. 6A to 6C and 8 are diagrams illustrating an example display screen of terminal A chatting with terminal B. FIGS. 7A to 7D are diagrams illustrating an example display screen of terminal B chatting with terminal A. Here, terminal A has a content playback application (music app) installed therein, and intends to transmit a song to terminal B.

As illustrated in FIG. 5, the server 100 stores permission information relating to the music app for terminals engaged in a chat, in the storage unit 120 (step S11). According to at least some example embodiments, step S11 may be performed in advance of the other steps shown in FIG. 5.

The server 100 receives a song request from terminal A chatting with terminal B (step S12).

Next, the server 100 causes the creation unit 132 to create (or generate) data for displaying a menu for a song requested by terminal A on the display screens of terminal A and terminal B, and causes the transmission unit 112 to transmit the data to terminal A and terminal B (step S13).

The processing in the above steps will be described below with reference to the display screen of terminal A.

FIGS. 6A, 6B and 6C are diagrams illustrating transition of the display screen of terminal A.

As illustrated in FIGS. 6A, 6B and 6C, a chatroom in which terminal A chats with terminal B is displayed on the display screen of terminal A.

As illustrated in FIG. 6A, terminal A receives a message 251 of “What tunes have you been listening to lately?” from terminal B. The user of terminal A taps the “+” button in the lower left part of the display screen to display a menu list of the message app, and taps a “LINE Music” button 252 in the menu list. Then, as illustrated in FIG. 6B, LINE Music (music app) is started up in terminal A, and a song list 253 of songs listened to via terminal A is displayed on the display screen. From the song list, the user of terminal A can tap and select a song the user wishes to share with terminal B. As illustrated in FIG. 6C, the song selected from the song list 253 is displayed in the form of a message 254 in the chatroom. The message 254 includes information on the song (e.g., the title, the artist and the album cover photo) and a play button 255.

FIG. 7A illustrates the corresponding display screen of terminal B in this situation.

As illustrated in FIG. 7A, on the display screen of terminal B, the information on the song and a play button 352 are displayed in the form of a message 351 transmitted from terminal A. The user of terminal B taps the play button 352 if the user wishes to listen to the song transmitted from terminal A.

Referring back to the flowchart in FIG. 5, the subsequent processing in the server 100 will be described.

Upon the play button 352 being tapped on terminal B, an information processing unit 231 in terminal B creates app information regarding whether or not the music app is installed on terminal B. A communication unit 210 transmits the app information and an instruction to play the song to the server 100.

Upon receipt of the playback instruction from terminal B (step S14), the determination unit 131 at the server 100 determines whether or not terminal B is permitted to use the music app, based on the app information (step S15).

If it is determined that terminal B is not permitted to use the music app, then the creation unit 132 at the server 100 creates a message asking whether or not the user wishes to install the music app, and the transmission unit 112 transmits the created message to terminal B (step S19). Here, on the display screen of terminal B, as illustrated in FIG. 7B, a pop-up message 353 of “LINE Music is not installed. Do you want to install it?” is displayed.

If it is determined in step S15 that terminal B is permitted to use the music app, then the determination unit 131 at the server 100 determines whether or not terminal B has a license to use and/or access the content, based on the permission information table 121 (step S16).

If it is determined that terminal B has a license, then the creation unit 132 creates response data so that terminal B can fully play the song, and transmits the response data to terminal B (step S17).

If it is determined in step S16 that terminal B does not have a license to use and/or access the content, then the creation unit 132 creates response data so that terminal B can play only part of the song, and transmits the response data to terminal B (step S18). In this case, in the lower part of the display screen of terminal B, as illustrated in FIG. 7D, a pop-up message 356 of “Sample playback” is displayed and playback of only a part of the song is started at terminal B. In this step, in a message 355 including the information on the song, a stop button 355 is displayed.

If it is determined in step S16 that terminal B does not have a license to use and/or access the content, as illustrated in FIG. 7C, a pop-up message 354 asking whether or not to purchase a license to use and/or access content may be displayed on the display screen of terminal B. If the user of terminal B taps “Yes” in the pop-up message 354 to purchase a license, then a website or a page for purchasing a license for the music app is displayed on the display screen of terminal B. At the end of processing for terminal B to purchase the license, the display screen returns to the chat screen and the song is fully played. On the other hand, if the user of terminal B taps “No” in the pop-up message 354, then only part of the song is played.

FIG. 8 is a diagram illustrating another example of the display screen of terminal A.

As illustrated in FIG. 8, terminal A can transmit a song to terminal B in the form of a chat message 256. Also, as illustrated in a message 257, terminal A can transmit not only a song alone, but also a song list (playlist). If the music app is installed on terminal B, upon the user tapping a message corresponding to the message 257 on the display screen of terminal B, then the play list is displayed on the display screen of terminal B. Furthermore, upon selection of a song in the list, terminal B can fully play the song if terminal B has a license, and play only part of the song if terminal B does not have a license.

As illustrated in FIG. 8, chatting between the terminals can continue while the song is being played, and in addition, sharing songs with a chat companion enables exchange between the users to be deepened more.

Although the above-described example embodiment has been described in terms of a case where a terminal can fully play a song if the terminal has a license, a user whose license is of the “time-fixed type” may not wish the total time in which the user can use and/or access content data to decrease as a result of the playback of the song. Therefore, after determining that the terminal has a license in step S16, the determination unit 131 may determine the type of the license. If it is determined that the terminal has a license of the “time-fixed type”, a pop-up message asking whether or not to fully play the song may be displayed on the terminal of the user to let the user choose whether to play the entire song or only part of the song. Consequently, a user may avoid decreasing the total time for a user whose license is of the “time-fixed type” as a result of playback of an undesirable song.

Also, if it is determined in step S15 that terminal B is not permitted to use the music app, then terminal B may only play part of the song. In this case, since the music app is not installed, a general application for music playback that can be used on the message app may be started up to play the song.

As described above, one or more example embodiments may suppress and/or eliminate the need to, when playing content such as music and/or video transmitted from a chat companion while chatting, display a screen that is separate from a chatroom on a terminal of a user, which may suppress and/or prevent the user from having a feeling of troublesomeness. Furthermore, even if a user does not have a license to use and/or access content (e.g., music and/or video content) in a content playback application that has been transmitted from a chat companion, a part of the music or video may be played, which is may be more convenient for the user as compared to a case where the music and/or video cannot be played at all, and enables exchange between users to be deepened. Furthermore, a user that has listened to a part of a song is more likely to purchase a license to use the content playback application in order to fully listen to the song, which is advantageous to a distributer of the content playback application.

Although some example embodiments have been described above, it should be understood that the disclosure should not limited to these examples. For example, although the above description has been described in terms of a case where only part of the content is played if a terminal does not have a license to use a content playback application, the content may be played with the quality lowered by, for example, thinning out the sound digital data. In this case, content is played with a relatively high quality for a user having a license, which makes a user without a license have a feeling of envy, thereby urging the user to purchase a license.

Also, although the above-described example embodiments have been described in terms of modes of playback of songs, videos and other content also fall within the scope of this disclosure. For example, if information on a video is received as a message, then video may be displayed with a size that does not hide the chat screen on the display screen of the relevant terminal device when the video is played. In a user terminal that does not have a license to use the content playback application, only a part of the video may be played, or the video may be played with the quality lowered by thinning out the frames, or with lowered resolution.

Although example embodiments have been described in terms of a case where a content playback application is installed in terminal A (or the terminal device 200), there may be cases where the content playback application is not installed in terminal A. In these case, upon the user selecting (tapping) the “LINE Music” button 252 on the menu list displayed on the display screen of terminal A in FIG. 6A, the determination unit 131 determines whether or not terminal A is permitted to use the content playback application.

If the determination unit 131 determines that terminal A is not permitted to use the content playback application, for example, as illustrated in FIG. 7B, then the creation unit 132 creates response data that causes the terminal A to display a pop-up message asking whether or not to obtain permission to use the content playback application (e.g., whether or not to install the app). Consequently, the advantage of being able to urge a user of a terminal to install a content playback application is provided.

Although example embodiments have been described in terms of a case where a content playback application is used for content playback and content sharing, example embodiments should not be limited to this case. For example, if a content playback function is incorporated as a function of a messaging application, then the content playback function may be used for content playback and/or content sharing. In this case, the content playback function includes all of the functions to be executed in a content playback application, and the description of the above-described example embodiment may be provided with the “content playback application” replaced by the “content playback function”. In such case, the processing for urging installation of a content playback application may be omitted.

Although example embodiments have been described in terms of a case where the server 100 makes a determination regarding permission to use a content playback application, example embodiments should not be limited to this case. For example, the control unit 230 in the terminal device 200 may make a determination regarding permission to use a content playback application. In such case, the control unit 230 in the terminal device 200 may create a message asking whether or not to install the content playback application.

Also, the terminal devices 200 and 300 should not be limited to smartphones. Each of the terminal devices may be any device having an information processor and/or processing circuitry capable of providing functions described herein with regard to one or more example embodiments. For example, one or more of the terminal devices 200 and 300 may be a mobile terminal, a mobile phone, a PC (personal computer), a tablet terminal, etc. Furthermore, although the above-described example embodiments have been described in terms of a case where chatting is done between two terminal devices, example embodiments should not be limited to this case. Rather, example embodiments are also applicable to cases where chatting is done among three or more terminal devices. In such cases, for each terminal device, the determination unit 131 at the server 100 determines whether or not the terminal device has a license to use and/or access content in the content playback application.

Example embodiments disclosed herein may include program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits (or circuitry) and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

According to at least some example embodiments, one or more of the functional units in the server 100 may be provided by hardware (e.g., a logic circuit) or a dedicated circuit formed as, for example, an integrated circuit ((IC) chip or an LSI (large-scale integration)), one or more of the processing circuitry discussed above, etc. Also, each functional unit may be provided by processing circuitry, such as one or more integrated circuits, or functions of a plurality of functional units may be provided by one integrated circuit. LSI may be referred to as VLSI, super LSI or ultra LSI depending on integration density.

If one or more functional units in the server 100 are implemented in connection with program code including program instructions, software components, software modules, data files, data structures, and/or the like, that are implemented by one or more physical hardware devices, then the server 100 or the terminal devices 200 and 300 may include, for example, processing circuitry configured to execute commands, a ROM (read-only memory) and/or a storage device (referred to as “recording medium”), such as those described herein, in which the program and various data are recorded in a computer (or CPU)-readable manner, and a RAM (random access memory).

One or more example embodiments may be achieved by a computer (or the CPU) reading the program from the recording medium and executing the program. For the recording medium, a “non-transitory computer-readable storage medium”, such as those discussed herein, may be used. Also, the above program may be supplied to the computer via an arbitrary transmission medium that can transmit the program (e.g., a communication network or broadcast wave). The program may be provided using, for example, a script language such as ActionScript or JavaScript (registered trademarks), an object-oriented programming language such as Objective-C or Java (registered trademarks) or a markup language such as HTML5.

Although example embodiments have been described with regard to the drawings, it should be noted that a person skilled in the art can easily make various alternations and modifications based on the present disclosure. Accordingly, it should be noted that these alterations and modifications also fall within the scope of example embodiments. For example, the functions and the like included in the respective means, the respective steps and the like can be relocated so as to prevent logical contradiction, and a plurality of means or steps or the like can be combined into one, or one means or step or the like can be divided into a plurality of units or steps or the like. Also, the configurations indicated in the above-described example embodiments may be arbitrarily combined.

According to at least some example embodiments, servers, server control methods, and non-transitory computer-readable mediums, may enhances user-friendliness in terms of content playback during chatting.

While some example embodiments have been described with reference to the drawings, it will be apparent to those skilled in the art that various changes and modifications may be made without departing from the spirit and scope of this disclosure. Therefore, it should be understood that the above embodiments are not limiting, but illustrative.

What is claimed is:

1. A server comprising:
a transceiver configured to receive a request for content from a first terminal device through a first application, and to transmit response data to the first terminal device and a second terminal device;
at least one memory configured to store permission information indicative of whether the first terminal device and the second terminal device are permitted to access the requested content, the at least one memory having computer-readable instructions stored therein;
at least one processor configured to execute the computer-readable instructions to
determine whether the second terminal device is permitted to access the requested content based on the permission information stored in the memory, and
generate the response data based on a result of the determination; wherein
if the second terminal device is permitted to access the requested content, then the at least one processor is configured to execute the computer-readable instructions to generate the response data enabling the second terminal device to play the requested content at a first level, and
if the second terminal device is not permitted to access the requested content, then the at least one processor is configured to execute the computer-readable instructions to generate the response data enabling the second terminal device to play the requested content at a second level, the second level being inferior to the first level.

2. The server according to claim 1, wherein
the first application is a messaging application configured to exchange messages between the first terminal device and the second terminal device; and
the request for content is transmitted as a message by the first terminal device.

3. The server according to claim 1, wherein if the second terminal device is not permitted to access the requested content, then the at least one processor is configured to execute the computer-readable instructions to generate the response data enabling the second terminal device to play only a portion of the requested content.

4. The server according to claim 1, wherein if the second terminal device is permitted to access the requested content, then the at least one processor is configured to execute the computer-readable instructions to generate the response data enabling the second terminal device to play the entirety of the requested content.

5. The server according to claim 1, wherein if the second terminal device is not permitted to access the requested content, then the at least one processor is configured to execute the computer-readable instructions to generate the response data enabling the second terminal device to play the requested content only with a low quality.

6. The server according to claim 1, wherein if the second terminal device is not permitted to access the requested content, then the at least one processor is configured to execute the computer-readable instructions to generate the response data enabling the second terminal device to play the requested content with a high quality.

7. The server according to claim 1, wherein
the permission information includes use time information indicative of a total time during which the requested content is accessible by the second terminal device;
the at least one processor is configured to execute the computer-readable instructions to
determine, based on the use time information, whether the total time during which the second terminal device is able to access the requested content is limited, and
determine whether the total time is decreased by accessing the requested content; and
if the total time in which the second terminal device is able to access the requested content is limited and the total time is decreased by accessing the requested content, then the at least one processor is configured to execute the computer-readable instructions to generate, for the second terminal device, the response data asking whether to play the entirety of the requested content.

8. A method for controlling a server, the method comprising:
receiving a request for content from a first terminal device through a first application;
determining whether a second terminal device is permitted to access the requested content based on stored permission information, the stored permission information being indicative of whether the first terminal device and the second terminal device are permitted to access the requested content;
generating, based on a result of the determining, response data for the first terminal device and the second terminal device, the generated response data being associated with the request for content from the first terminal device; and
transmitting the generated response data to the first terminal device and the second terminal device; wherein
if the determining determines that the second terminal device is permitted to access the requested content, then the generating generates the response data enabling the second terminal device to play the requested content at a first level, and
if the determining determines that the second terminal device is not permitted to access the requested content, then the generating generates the response data enabling the second terminal device to play the requested content at a second level, the second level being inferior to the first level.

9. The method of claim 8, further comprising:
storing the permission information indicative of whether the first terminal device and the second terminal device are permitted to access the requested content.

10. A non-transitory computer-readable storage medium having embodied thereon computer-executable instructions that, when executed, causes the computer to execute a method comprising:
receiving a request for content from a first terminal device through a first application;
determining whether a second terminal device is permitted to access the requested content based on stored permission information, the stored permission information being indicative of whether the first terminal device and the second terminal device are permitted to access the requested content;
generating, based on a result of the determining, response data for the first terminal device and the second terminal device, the generated response data being associated with the request for content from the first terminal device; and
transmitting the generated response data to the first terminal device and the second terminal device; wherein
if the determining determines that the second terminal device is permitted to access the requested content, then the generating generates the response data enabling the second terminal device to play the requested content at a first level, and
if the determining determines that the second terminal device is not permitted to access the requested content, then the generating generates the response data enabling the second terminal device to play the requested content at a second level, the second level being inferior to the first level.

11. The non-transitory computer readable storage medium of claim 10, wherein the further comprises:
storing the permission information indicative of whether the first terminal device and the second terminal device are permitted to access the requested content.
